(19) United States
(12) Patent Application Publication
(10) Pub. No.: US 2012/0298483 A1
(43) Pub. Date: Nov. 29, 2012

(54) DRIVE APPARATUS

(75) Inventor: Günther Weber, Gross Nemerow (DE)

(73) Assignee: WEBER MASCHINENBAU GMBH BREIDENBACH, Breidenbach (DE)

(21) Appl. No.: 13/477,689

(22) Filed: May 22, 2012

(30) Foreign Application Priority Data
May 24, 2011 (DE) 102011102432.1

(51) Int. Cl. B65G 23/22; H02K 16/00; H02K 7/14

(52) U.S. Cl. 198/570; 310/112

(57) ABSTRACT

The invention relates to a drive apparatus having a coaxial shaft arrangement which includes a plurality of drive shafts which are arranged coaxially to one another at least regionally and whose respective axes of rotation lie on a common rotational drive axis; and an electric drive motor which includes a rotor arrangement which includes a plurality of rotors arranged coaxially to one another at least regionally and/or behind one another, with the axis of rotation of each rotor lying on the common rotational drive axis and forming one of the drive shafts or being connected to one of the drive shafts, wherein the drive motor is controllable such that the rotors can be driven independently of one another.

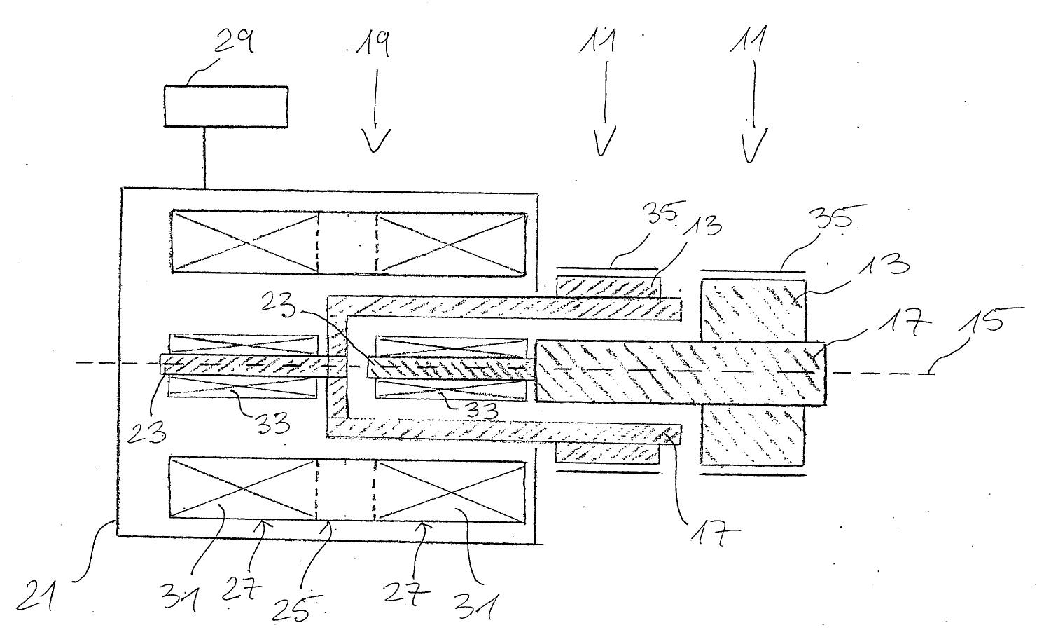

This patent application claims the benefit of priority to German Patent Application Serial No. 102011102432.1, filed May 24, 2011 which is incorporated herein by reference in its entirety.

The invention relates to an apparatus for the multi-track conveying of articles, in particular of individual slices or slice portions of sliced food products or of food products to be sliced, having a plurality of conveyors, in particular continuous conveyor belts, which are arranged next to one another and which each include at least one drive member, in particular a roller or a roll for one or more continuous belts, rotatingly drivable about an axis, wherein the axes of the drive members lie on a common rotational drive axis.

The invention additionally relates to a drive apparatus having a coaxial shaft arrangement which includes a plurality of drive shafts which are arranged coaxially to one another at least regionally and whose axes of rotation each lie on a common rotational drive axis.

A change is increasingly being made, in particular in the technical sector of slicing food products such as sausage or cheese using high-speed slicers, to slice a plurality of products simultaneously, with the products being supplied simultaneously on a plurality of tracks to a rotating blade of the slicer. To obtain individual slices or slice portions of the same weight, the product feed must be able to supply the products independently of one another in the individual tracks, i.e. the individual conveyor tracks must be drivable independently of one another. With regard to the multi-track transport of the slices or portions, it is likewise desired to work with individual tracks, i.e. the conveyors for the slices or portions associated with the individual tracks must be able to be operated independently of one another. These conveyors are in particular each formed by a continuous conveyor belt which includes a rotatingly drivable roll or roller around which the continuous belt is guided. These drive rolls or drive rollers lie on a common rotational drive axis. Without the requirement of a track-individual conveying, a common drive shaft with a single common drive motor could be provided to drive the individual conveyor belts simultaneously and always in the same manner, i.e. with the same conveying direction and at the same conveying speed. If—as described above—an independent drive of the conveyors is required, it is obviously not possible to work with a single common drive shaft. There is thus a need for a solution, in particular in the above-explained technical sector, both for the multi-track product supply before the cutting process and for the multi-track transporting away of the slices or portions after the cutting process, which allows a track-individual operation of a plurality of conveying devices in a simple and space-saving structure and with a faster and more precise controllability.

It is therefore the object of the invention to provide such a solution, wherein this should admittedly take place in particular for the technical sector of the conveying of food products, but this solution should also be able to be used in other technical sectors.

This object is satisfied by the features of the independent claims.

The conveying apparatus in accordance with the invention includes a coaxial shaft arrangement which includes a plurality of drive shafts which are arranged coaxially to one another at least regionally, with the axis of rotation of each drive shaft lying on the common rotational drive axis and forming one of the drive members or being connected to one of the drive members; at least one electric drive motor for driving the drive shafts, with the drive motor including a rotor arrangement whose axis of rotation coincides with the rotational axis drive axis; and a control device which is designed to control the drive motor such that the conveyors can be driven independently of one another.

In accordance with the invention, the rotor arrangement of the drive motor is also arranged on the common rotational drive axis and thus in a particularly space-saving manner.

A plurality of electric drive motors can be arranged behind one another and/or lying at least partly in one another, with each drive motor driving at least one drive shaft. Such a “cascaded” arrangement of electric motors also has the advantage of a drive requiring little construction space which solves the initially described problem in an elegant manner due to the circumstance that the rotors lie on the common rotational drive axis.

Alternatively, a common drive motor can be provided for at least two drive shafts. This common drive motor can include a rotor arrangement of at least two rotors which are arranged coaxially to one another or behind one another and whose axes of rotation each lie on a common rotational drive axis. In this respect, each rotor can form one of the drive shafts or be connected to one of the drive shafts.

A single drive motor can also be provided for all drive shafts. Provision can alternatively be made to drive some of the drive shafts using a first common drive motor on the one side of the coaxial shaft arrangement or of the total arrangement and to provide a second common drive motor on the other side for the other drive shafts. The conveyors then lie between the two drive motors. In this respect, the drive shafts can be divided 50:50 to the two drive motors so that the one half of the drive shafts is driven by the one side and the other half of the drive shafts is driven by the other side. Alternatively, an asymmetric division can also be made so that e.g. with a total of six drive shafts, one drive motor on the one side drives four drive shafts and one drive motor on the oppositely disposed side drives two drive shafts.

A division of the drive of the drive shafts of any type whatsoever to two drive motors driving at oppositely disposed sides is particularly advantageous in an application in which a plurality of conveyors, in particular continuous conveying belts, disposed next to one another are to be driven separately from one another.

A possible specific embodiment provides that the drive motor includes at least one common stator associated with at least two rotors, with the rotors being individually controllable by means of the control device. In this respect, the stator can be formed for generating a common magnetic field for the rotors and each rotor can have its own device which can be acted on by a current varying over time.

In this respect, the track individualization required for an independent operation of the conveyors consequently takes place via the individual rotors of the drive motor, i.e. by a corresponding independent control or excitation of the devices which are associated with the individual rotors and which are in each case coils or windings which can be acted on by an electric current.

The above-mentioned independent control of the rotors also includes a possible variant in which e.g. the rotors or coils of the rotors are admittedly acted on by an electric current in the same manner with respect to one another, but the track individualization takes place by a track-specific screening or attenuating of a magnetic field provided by the common stator variable by control.

Alternatively, the track individualization can also take place by a corresponding track-specific embodiment or control of the stator of the drive motor in that e.g. the stator has a plurality of stator sections which are each associated with one of the rotors and which can be controlled independently of one another for the respective generation of a magnetic field variable over time. Provision can be made by suitable means that each stator section substantially only cooperates with the rotor associated with it.

The above-explained aspect of the invention thus relates to a multi-track conveying apparatus having a coaxial shaft arrangement which is driven by at least one electric motor likewise arranged on the common rotational drive axis.

The likewise above-explained aspect of a single electric motor which in particular includes a coaxial arrangement and/or sequential arrangement of a plurality of rotors as a drive for a coaxial shaft arrangement is, in accordance with the invention, not restricted to conveying applications, but can be used universally in accordance with the object underlying the invention.

In accordance with a further aspect, the invention is accordingly directed to a drive apparatus which includes a coaxial shaft arrangement and an electric drive motor, in particular exactly one electric drive motor, with the coaxial shaft arrangement including a plurality of drive shafts which are arranged coaxially to one another at least regionally and whose rotational axes each lie on a common rotational drive axis and the electric drive motor includes a rotor arrangement which includes a plurality of rotors arranged coaxially to one another at least regionally or behind one another, with the axis of rotation of each rotor lying on the common rotational drive axis and forming one of the drive shafts or being connected to one of the drive shafts, and with the drive motor being controllable such that the rotors can be driven independently of one another.

In accordance with a further aspect, the invention relates to the use of a coaxial shaft arrangement and of at least one electric drive motor, in particular of exactly one electric drive motor, for driving a conveying apparatus having a plurality of conveyors, in particular continuous conveyor belts, arranged next to one another, with the coaxial shaft arrangement including a plurality of drive shafts which are arranged coaxially to one another at least regionally and whose axes of rotation each lie on a common rotational drive axis, and with the electric drive motor including a rotor arrangement which includes a plurality of rotors arranged coaxially to one another at least regionally or behind one another, with the axis of rotation of each rotor lying on the common rotational drive axis and forming one of the drive shafts or being connected to one of the drive shafts.

The number of drive shafts can generally be as desired in principle. In particular two, three, four, five or six drive shafts are provided, with a larger number of drive shafts also being able to be provided, and indeed both an even number and an odd number of drive shafts.

If the invention is used for the independent drive of a plurality of conveyors, in particular continuous conveyors, disposed next to one another, the invention can be used particularly advantageously to transport away on multiple tracks slices or slice portions produced by means of a slicer by slicing a plurality of food products supplied next to one another and to align them within the framework of this transporting away, e.g. before the actual process of transporting away or during the transport. The invention makes this possible by the ability to drive the individual conveyors independently of one another, with e.g. one or more conveyors also being able to be brought to a standstill temporarily as required, whereas a transport movement continues to take place in the other tracks.

The invention will be described in the following by way of example with reference to the drawing whose only FIGURE shows a coaxial arrangement of two drive shafts which are driven by a single common electric motor which includes two rotors which are arranged behind one another and which are each rotationally fixedly connected to one of the drive shafts.

The conveying apparatus in accordance with the invention shown schematically in the FIGURE includes two conveyors 11 which each include a continuous conveyor belt 35 and a drive member 13 about which the conveying belt 35 is guided and which can be set into rotation to drive the conveyor belt 35. The two conveyor belts 35 disposed next to one another each form a conveying track along which generally any desired number of articles can be transported in both directions and at generally any desired conveying speed, in particular conveying speeds differing from one another.

The conveyors 11 can be driven independently of one another, and indeed by means of a drive apparatus in accordance with the invention which includes an electric motor 19 and two drive shafts 17 which are arranged lying in one another regionally. A radially inner drive shaft 17 is connected to the conveyor 11 at the right in the FIGURE, and indeed by a rotationally fixed coupling to the drive member 13. A radially outer drive shaft 17 is connected 13 to the conveyor 11 at the left in the FIGURE by a rotationally fixed coupling to the drive member. The outer diameter of the two drive members 13 is of equal size so that the two continuous conveying belts 35 disposed next to one another lie in a common transport plane.

The common rotational drive axis 15 of this arrangement of drive shafts 17 and drive motor 19 coincides with the axes of rotation of the drive shafts 17, drive members 13 and rotors 23.

The electric motor 19 includes two rotors 23 arranged behind one another along the rotational drive axis 15. The rotor 23 at the right in the FIGURE is rotationally fixedly connected to the radial inner drive shaft 17, whereas the rotor 23 at the left in the FIGURE is connected to the radially outer drive shaft 17.

The electric motor 19 furthermore includes a stator arrangement for the two rotors 23 which will be looked at in more detail in the following. The stator arrangement and the rotors 23 are located in a common housing 21 of the electric motor 19.

The electric motor 19 is connected to a control device 29 which is a component of a further control device of a higher level apparatus, not shown, or which can be connected to this further control device, with the higher level apparatus being one in which the conveyors 11 are integrated in any manner or in connection with which the conveyors 11 can be used. The higher level apparatus can in particular be a high-speed slicer which simultaneously slices a plurality of food products, with the conveyors 11 serving to transport away the arising slices or slice portions. The operation of the conveyors 11 is controlled via the electric motor 19 by means of the control device 29 in accordance with the respective requirements.

The arrangement in accordance with the invention makes it possible to operate the conveyors 11 independently of one another. Within the framework of the above-explained application, for example, this independent operation can in particular be utilized to align slices or slice portions lying on the continuous conveyor belts 35 with respect to an (imaginary) line extending transversely to the conveying direction in order e.g. hereby to supply the slices or slice portions to one or more downstream devices in an aligned configuration.

The independent operation of the conveyors 11 is achieved in that the electric motors 19 is correspondingly controlled by means of the control device 29. The FIGURE simultaneously illustrates two possible variants for such a track-individualized control.

In a first variant, a common stator 25 can be provided for the two rotors 23 which generates a magnetic field unvaried over time, with each rotor 23 being provided with a device 33, in particular in the form of one or more coils or windings, which makes it possible to act on the rotor 23 by an electric current variable over time. This control of the rotors 23 can take place independently of one another for the two rotors 23 so that any desired direction of rotation and any desired rotational speed can be imparted to each of the two rotors 23 at any point in time. The track-individual drive of the two continuous belts 35 can take place in this manner.

The same result can be achieved in accordance with a second variant in which the rotors 23 are designed as passive, i.e. are not individually controllable, in that the rotors 23 are e.g. provided with permanent magnets. The track-individualization takes place by a corresponding embodiment and control of the stator arrangement which e.g. includes two stator sections 27 which are disposed axially behind one another and which are each provided with a device 31, in particular in the form of one or more coils or windings, which makes it possible to generate a magnetic field which varies over time and with which the respective associated rotor 23 cooperates. The stator sections 27 are indicated by dashed lines in the FIGURE.

It is understood that the above-described drive principle and its variants explained by way of example can generally be extended to any desired number of drive shafts. A single electric drive motor is in principle sufficient for this purpose. It is also possible to arranged a respective electric motor 19 on both sides of the conveyors 11 which drives some of the drive shafts 17, for example precisely half, and thus the continuous conveyor belts 35.

The above-explained embodiments can in particular be used in conjunction with a high-speed slicer for the simultaneous slicing of a plurality of food products, but are not restricted to such a use. The drive principle in accordance with the invention is generally suitable for any desired applications.

1. An apparatus for the multi-track conveying of articles having a plurality of conveyors, which are arranged next to one another and which each include at least one respective drive member rotatingly drivable about an axis, wherein the axes of the drive members lie on a common rotational drive axis;
having a coaxial shaft arrangement which includes a plurality of drive shafts which are arranged coaxially to one another at least regionally, with the axis of rotation of each drive shaft lying on the common rotational drive axis and forming one of the drive members at the output side or being connected to one of the drive members;
having at least one electric drive motor for driving the drive shafts, with the drive motor including a rotor arrangement whose axis of rotation coincides with the rotational drive axis; and
having a control device which is designed to control the drive motor such that the conveyors can be driven independently of one another.

2. An apparatus in accordance with claim 1, wherein said articles are selected from the group comprising individual slices of food products, slice portions of sliced food products and products to be sliced.

3. An apparatus in accordance with claim 1, wherein the conveyors are continuous conveyors.

4. An apparatus in accordance with claim 1, wherein said drive members include a roll or a roller for one or more continuous belts.

5. An apparatus in accordance with claim 1, wherein exactly one electric drive motor is provided whose rotor arrangement includes a plurality of rotors arranged coaxially to one another at least regionally and/or behind one another, with the axis of rotation of each rotor lying on the common rotational drive axis and forming one of the drive shafts or being connected to one of the drive shafts.

6. An apparatus in accordance with claim 1, wherein the drive motor includes a stator having a plurality of sections or a plurality of stators, with each sector section or stator being associated with one of the rotors and being individually controllable by means of the control device.

7. An apparatus in accordance with claim 6, wherein the stator sections or stators are controllable independently of one another in each case for generating a magnetic field variable over time.

8. An apparatus in accordance with claim 7, wherein the rotors are each provided with at least one permanent magnet.

9. An apparatus in accordance with claim 1, wherein the drive motor includes at least one common stator associated with at least two rotors, with the rotors being individually controllable by means of the control device.

10. An apparatus in accordance with claim 9, wherein the stator is formed for generating a common magnetic field for the rotors and each rotor has its own device which can be acted on by a current varying over time.

11. A drive apparatus comprising
a coaxial shaft arrangement which includes a plurality of drive shafts which are arranged coaxially to one another at least regionally and whose respective axes of rotation lie on a common rotational drive axis; and
an electric drive motor which includes a rotor arrangement which includes a plurality of rotors arranged coaxially to one another at least regionally and/or behind one another, with the axis of rotation of each rotor lying on the common rotational drive axis and forming one of the drive members or being connected to one of the drive shafts,
wherein the drive motor can be controlled such that the rotors can be driven independently of one another.

12. An apparatus in accordance with claim 11, wherein the drive motor includes a stator having a plurality of sections or a plurality of stators, with each sector section or stator being associated with one of the rotors and being individually controllable by means of the control device.

13. An apparatus in accordance with claim 12, wherein the stator sections or stators are controllable independently of one another in each case for generating a magnetic field variable over time.

14. An apparatus in accordance with claim 13, wherein the rotors are each provided with at least one permanent magnet.

15. An apparatus in accordance with claim 11, wherein the drive motor includes at least one common stator associated with at least two rotors, with the rotors being individually controllable by means of the control device.

16. An apparatus in accordance with claim 15, wherein the stator is formed for generating a common magnetic field for the rotors and each rotor has its own device which can be acted on by a current varying over time.

17. Use of an arrangement comprising
a coaxial shaft arrangement which includes a plurality of drive shafts which are arranged coaxially to one another at least regionally and whose respective axes of rotation lie on a common rotational drive axis; and
at least one an electric drive motor which includes a rotor arrangement which includes a plurality of rotors arranged coaxially to one another at least regionally and/or behind one another, with the axis of rotation of each rotor lying on the common rotational drive axis and forming one of the drive shafts or being connected to one of the drive shafts,
for driving a conveying apparatus having a plurality of conveyors arranged next to one another.

18. Use in accordance with claim 17, wherein the plurality of conveyors comprise continuous conveyor belts.
